(19) United States
(12) Patent Application Publication
(10) Pub. No.: US 2024/0105204 A1
(43) Pub. Date: Mar. 28, 2024

(54) SYSTEMS AND METHODS FOR GENERATION OF REAL-TIME REACTIONARY DEVICE DATA BASED ON LIVE AUDIO DATA

(71) Applicant: MIXHalo Corp., San Francisco, CA (US)

(72) Inventor: Christopher Rocco Levitas, San Francisco, CA (US)

(21) Appl. No.: 18/237,028

(22) Filed: Aug. 23, 2023

Related U.S. Application Data
(60) Provisional application No. 63/410,410, filed on Sep. 27, 2022.

(51) Int. Cl. G10L 25/51

(52) U.S. Cl. CPC G10L 25/51

(57) ABSTRACT

A method for generating real-time reactionary device data using a mobile computing device at a live event based on live audio data includes receiving a data representation of a live audio signal corresponding to the live event via a wireless network and processing the data representation of the live audio signal into a live audio stream. The method also includes calculating baseline characteristics of the live audio stream and determining one or more deviations from the baseline characteristics of the live audio stream. The method also includes generating reactionary device data based on the one or more deviations from the baseline characteristics of the live audio stream and initiating a device reaction based on the reactionary device data.

### CROSS REFERENCE TO RELATED APPLICATION

This application claims priority to and the benefit of U.S. Provisional Patent Application No. 63/410,410, filed on Sep. 27, 2022, the entire disclosure of which is hereby incorporated by reference.

### FIELD OF THE INVENTION

This invention relates generally to the field of real-time delivery of data, such as audio and haptics, over wireless networks. More specifically, the invention relates to systems and methods for generation of real-time reactionary device data, such as haptic feedback data, based on live audio data.

### BACKGROUND

Advances in digital video recording are allowing users to never miss important or unique portions of live events, such as sporting events, while watching on a television or mobile device. Users can simply pause and rewind to the portion they may have missed and experience it as if they watched it live. However, users that are attending a live event do not have that capability, having to rely on watching a replay displayed at the venue. Therefore, there is a need for systems and methods that can alert a user at a live event when an important or unique experience is about to occur.

### SUMMARY

The methods and systems described herein advantageously provide for the automatic capture and analysis of live audio data associated with a live event to determine when deviations from baseline characteristics of the live audio occur, and initiate corresponding sensory reactions on mobile computing devices to alert users that a unique or noteworthy event is going to happen. The present invention includes systems and methods for generating real-time reactionary device data based on live audio data. For example, the present invention includes systems and methods for calculating baseline characteristics of a live audio stream and determining one or more deviations from the baseline characteristics of the live audio stream. The present invention also includes systems and methods for generating reactionary device data based on the one or more deviations from the baseline characteristics of the live audio stream and initiating a device reaction based on the reactionary device data.

In one aspect, the invention includes a computerized method for generating real-time reactionary device data based on live audio data using a mobile computing device at a live event. The computerized method includes receiving a data representation of a live audio signal corresponding to the live event via a wireless network. The computerized method also includes processing the data representation of the live audio signal into a live audio stream. The computerized method also includes calculating baseline characteristics of the live audio stream. The computerized method also includes determining one or more deviations from the baseline characteristics of the live audio stream. The computerized method also includes generating reactionary device data based on the one or more deviations from the baseline characteristics of the live audio stream. The computerized method also includes initiating a device reaction based on the reactionary device data.

In some embodiments, the computerized method further includes receiving the data representation of the live audio signal corresponding to the live event from an audio server computing device via the wireless network.

In some embodiments, the live audio stream includes commentary corresponding to the live event. For example, in some embodiments, the baseline characteristics of the live audio stream include an intonation of the commentary, a speech tempo of the commentary, and a loudness of the commentary.

In some embodiments, the computerized method further includes calculating the baseline characteristics of the live audio stream based on a machine learning algorithm. In other embodiments, the computerized method further includes determining the one or more deviations from the baseline characteristics of the live audio stream based on a machine learning algorithm.

In some embodiments, the device reaction corresponds to a vibration of the mobile computing device at the live event. For example, in some embodiments, an intensity of the vibration of the mobile computing device at the live event is based on the one or more deviations from the baseline characteristics of the live audio stream.

In some embodiments, the device reaction corresponds to a notification on a display of the mobile computing device at the live event. In other embodiments, the device reaction corresponds to an illumination of a display of the mobile computing device at the live event.

In another aspect, the invention includes a system for generating real-time reactionary device data based on live audio data. The system includes a mobile computing device at a live event communicatively coupled to an audio server computing device over a network. The mobile computing device is configured to receive a data representation of a live audio signal corresponding to the live event via the wireless network. The mobile computing device is also configured to process the data representation of the live audio signal into a live audio stream. The mobile computing device is also configured to calculate baseline characteristics of the live audio stream. The mobile computing device is also configured to determine one or more deviations from the baseline characteristics of the live audio stream. The mobile computing device is also configured to generate reactionary device data based on the one or more deviations from the baseline characteristics of the live audio stream. The mobile computing device is also configured to initiate a device reaction based on the reactionary device data.

In some embodiments, the mobile computing device at the live event is configured to receive the data representation of the live audio signal corresponding to the live event from the audio server computing device via the wireless network.

In some embodiments, the live audio stream includes commentary corresponding to the live event. For example, in some embodiments, the baseline characteristics of the live audio stream include an intonation of the commentary, a speech tempo of the commentary, and a loudness of the commentary.

In some embodiments, the mobile computing device at the live event is configured to calculate the baseline characteristics of the live audio stream based on a machine learning algorithm. In other embodiments, the mobile computing device at the live event is configured to determine the one or more deviations from the baseline characteristics of the live audio stream based on a machine learning algorithm.

In some embodiments, the device reaction corresponds to a vibration of the mobile computing device at the live event. For example, in some embodiments, an intensity of the vibration of the mobile computing device at the live event is based on the one or more deviations from the baseline characteristics of the live audio stream.

In some embodiments, the device reaction corresponds to a notification on a display of the mobile computing device at the live event. In other embodiments, the device reaction corresponds to an illumination of a display of the mobile computing device at the live event.

These and other aspects of the invention will be more readily understood from the following descriptions of the invention, when taken in conjunction with the accompanying drawings and claims.

### BRIEF DESCRIPTION OF THE DRAWINGS

FIG. 1 is a schematic diagram of a system architecture for generating real-time reactionary device data based on live audio data using a mobile computing device at a live event, according to an illustrative embodiment of the invention.

FIG. 2 is a detailed schematic diagram of a system architecture for generating real-time reactionary device data based on live audio data using a mobile computing device at a live event, according to an illustrative embodiment of the invention.

FIG. 3 is a schematic flow diagram illustrating generation of real-time reactionary device data based on live audio data using the system architecture of FIGS. 1 and 2, according to an illustrative embodiment of the invention.

### DETAILED DESCRIPTION

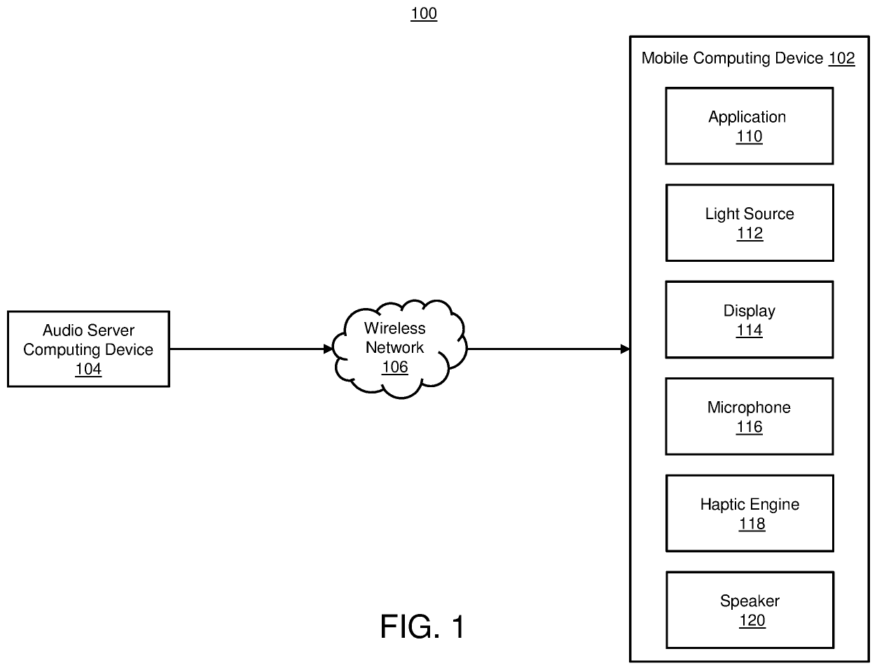

FIG. 1 is a schematic diagram of a system architecture 100 for generating real-time reactionary device data based on live audio data, according to an illustrative embodiment of the invention. System 100 includes a mobile computing device 102 communicatively coupled to an audio server computing device 104 over a wireless network 106. Mobile computing device 102 includes an application 110, a light source 112, a display 114, a microphone 116, a haptic engine 118, and a speaker 120. In some embodiments, the audio server computing device 104 is communicatively coupled to an audio interface (not shown).

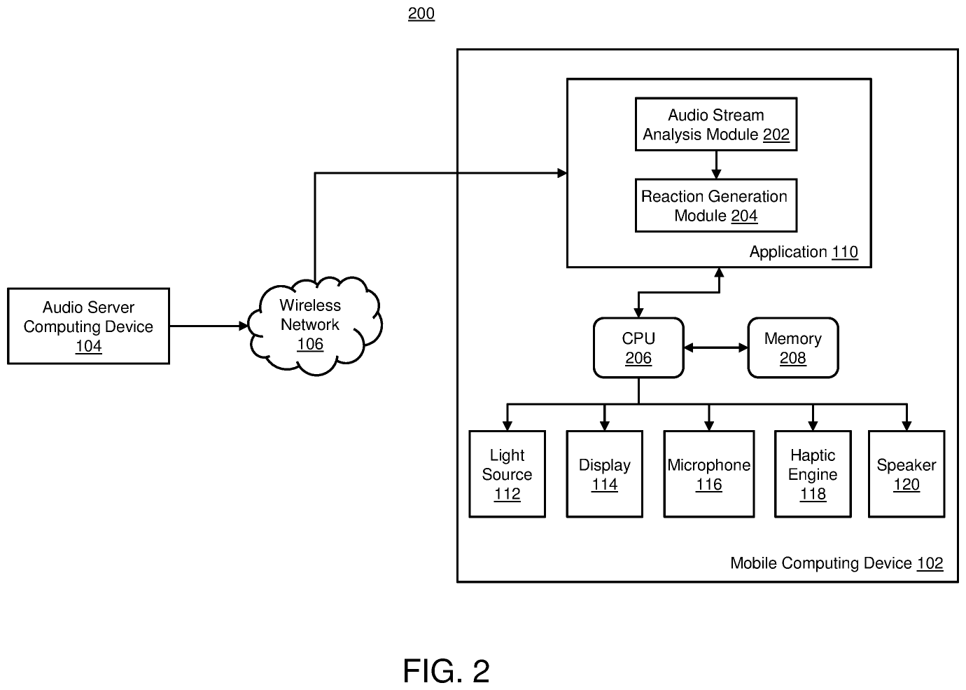

FIG. 2 is a detailed schematic diagram of a system architecture 200 for generating real-time reactionary device data based on live audio data, according to an illustrative embodiment of the invention. In addition to the components described above with respect to FIG. 1, application 110 includes an audio stream analysis module 202 that is configured to receive a data representation of a live audio signal corresponding to the live event from audio server computing device 104 via wireless network 106 and process the data representation of the live audio signal as described herein to determine one or more deviations in the live audio signal. Application 110 also includes a reaction generation module 204 that is configured to generate reactionary device data based on one or more of the deviations and initiate a device reaction based on the reactionary device data. FIG. 2 also illustrates the CPU 206 and memory 208 of mobile computing device 102. Generally, modules 202, 204 are specialized sets of computer software instructions which execute on one or more processors of server computing device 106 (e.g., CPU 206). In some embodiments, modules 202, 204 can specify designated memory locations and/or registers for executing the specialized computer software instructions.

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of client computing devices.

Mobile computing device 102 is configured to receive instructions from application 110 in order to generate real-time reactionary device data based on live audio data at a live event. For example, mobile computing device 102 is configured to receive a data representation of a live audio signal corresponding to the live event via wireless network 106. Mobile computing device 102 is also configured to process the data representation of the live audio signal into a live audio stream. In some embodiments, the mobile computing device 102 is configured to receive the data representation of the live audio signal corresponding to the live event from the audio server computing device 104 via the wireless network 106. In some embodiments, audio server computing device 104 is coupled to an audio source at the live event (e.g., a soundboard that is capturing the live audio).

An exemplary application 110 can be an app downloaded to and installed on the mobile computing device 102 via, e.g., the Apple® App Store or the Google® Play Store. The user can launch application 110 on the mobile computing device 102 and interact with one or more user interface elements displayed by the application 110 on a screen of the mobile computing device 102 to begin receiving the data representation of the live audio signal.

Mobile computing device 102 (e.g., via application 110) is also configured to calculate baseline characteristics of the live audio stream. For example, in some embodiments, the live audio stream includes live commentary corresponding to the live event. For example, when the live event is a sporting event, the live commentary can comprise commentary of one or more announcers who are watching and commenting on the sporting event as part of a broadcast presentation (e.g., radio, television). Mobile computing device 102 can capture one or more segments of the live audio stream and analyze the segments to determine baseline characteristics. For example, in some embodiments mobile computing device 102 continuously captures and analyzes segments of the live audio stream according to defined settings (e.g., 10-second segments, 20-second segments, 60-second segments) to determine baseline characteristics.

In some embodiments, mobile computing device 102 isolates a portion of the live audio stream that corresponds to the live commentary using e.g., one or more filters to minimize or remove background noise, crowd noise, or other audible artifacts in the live audio stream that do not correspond to the live commentary. Mobile computing device 102 can use the isolated live commentary to determine the baseline characteristics of the live audio stream as described herein.

In some embodiments, the baseline characteristics of the live audio stream include an intonation of the commentary, a speech tempo of the commentary, and a loudness of the commentary. In some embodiments, mobile computing device 102 can generate a waveform, a spectrogram, or other type of quantifiable representation of the live commentary from the live audio stream in order to determine the baseline characteristics. For example, mobile computing device 102 can measure characteristics of the speaker (or speakers) in the live commentary—such as pitch (in Hz), loudness (or sound pressure level) (in dB), timbre ascend time and timbre descend time (in seconds), time gaps in between words (in seconds), and so forth. Based upon values, or ranges of values, of each of the measured characteristics in the waveform/spectrogram, mobile computing device 102 can determine the baseline characteristics and store the baseline characteristics locally (e.g., in memory of mobile computing device 102).

As mentioned previously, during a particular sporting event (e.g., baseball), there may be key unique, exciting, or unexpected moments throughout the game, such as a home run or a game-ending double play. However, most of the action in the game is more routine or expected. Typically, the announcers providing the live commentary match the pattern of play—calling routine moments using certain speech characteristics or patterns and calling unique or exciting moments using different speech characteristics or patterns. In this example, because the more routine moments make up much of the commentary, these moments may be considered for determining the baseline characteristics.

In some embodiments, the baseline characteristics of the live audio stream include characteristics that are determined using speech recognition and/or emotion recognition techniques. For example, mobile computing device 102 can process the live audio stream using a speech recognition algorithm to recognize the content of words and/or phrases uttered as part of the commentary. Mobile computing device 102 can analyze the content of the words and/or phrases to, e.g., determine whether certain words or phrases are more commonly associated with routine moments or unique moments. Similarly, mobile computing device 102 can process the live audio stream using an emotion recognition algorithm to identify an emotion of the speaker. During unique moments, the commentary in the live audio stream may indicate that the speaker is experiencing a particular heightened emotion (e.g., excited, surprised)—while during routine moments, the commentary may indicate that the speaker is not experiencing any heightened emotions. Mobile computing device 102 can associate the determined emotion(s) for routine moments with the baseline characteristics of the live audio stream.

In some embodiments, mobile computing device 102 is configured to calculate the baseline characteristics of the live audio stream using a machine learning algorithm. Generally, machine learning is defined as enabling computers to learn from input data without being explicitly programmed to do so by using algorithms and models to analyze and draw inferences or predictions from patterns in the input data. Typically, the learning process is performed iteratively—e.g., a trained machine learning model analyzes new input data, and the output is compared against expected output to refine the performance of the model. This iterative aspect allows computers to identify hidden insights and repeated patterns and use these findings to adapt when exposed to new data. As can be appreciated, machine learning algorithms and processing can be applied by mobile computing device 102 when analyzing the live audio stream to determine the baseline characteristics. In some embodiments, the machine learning model used to determine the baseline characteristics is a classification model—where the model receives as input certain variables or attributes of the live audio stream during a defined time window (e.g., last 10 seconds) and analyzes the input data to generate a classification or label for the live audio stream during that time window. For input data that aligns with expected baseline characteristics, the model can classify the input data as ‘baseline.’

Mobile computing device 102 is also configured to determine one or more deviations from the baseline characteristics of the live audio stream. Continuing with the above example, mobile computing device 102 can generate a waveform, a spectrogram, or other type of quantifiable representation of the live commentary from the live audio stream in order to determine the one or more deviations from the baseline characteristics. As mentioned previously, mobile computing device 102 can measure characteristics of the speaker (or speakers) in the live commentary—e.g., pitch, timbre, loudness, intonation, speech tempo, speech context, and so forth—during a defined time period. Based upon values, or ranges of values, of each of the measured characteristics in the waveform/spectrogram for the defined time period, mobile computing device 102 can compare the values of the measured characteristics to the values of the baseline characteristics and determine whether the measured characteristics deviate from the baseline characteristics. In some embodiments, mobile computing device 102 can compare the value of each measured characteristic to a value of a corresponding baseline characteristic and generate a deviation value when the measured characteristic value differs from the baseline characteristic value. In some embodiments, mobile computing device 102 can determine a deviation when the measured characteristic value is different from the baseline characteristic. In some embodiments, mobile computing device 102 can determine a deviation when the measured characteristic value is different from the baseline characteristic by more than a predefined amount and/or percentage value.

In some embodiments, mobile computing device 102 can determine that a certain segment of the live audio stream comprises a deviation from the baseline live audio stream when at least one measured characteristic is different from a corresponding baseline characteristic. In some embodiments, mobile computing device 102 can determine that a certain segment of the live audio stream comprises a deviation from the baseline live audio stream when all of the measured characteristics are evaluated in aggregate against the corresponding baseline characteristics of the live audio stream. Mobile computing device 102 can store the one or more deviations locally (e.g., in memory of mobile computing device 102).

In some embodiments, mobile computing device 102 is configured to determine the one or more deviations from the baseline characteristics of the live audio stream using a machine learning algorithm. Like determining the baseline characteristics as described above, mobile computing device 102 the machine learning model can use a trained machine learning model to determine the one or more deviations. In some embodiments, the model used to determine the deviations is a classification model—where the model receives as input certain variables or attributes of the live audio stream during a defined time window (e.g., last 10 seconds) and analyzes the input data to generate a classification or label for the live audio stream during that time window. For input data that does not align with baseline characteristics (also called an ‘outlier’), the model can classify the input data as ‘deviation.’

Example machine learning algorithms and model frameworks that can be deployed in mobile computing device 102 to determine the baseline characteristics of the live audio stream and the one or more deviations from the baseline are described in (i) A. Bou Nassif et al., “Speech Recognition Using Deep Neural Networks: A Systematic Review,” IEEE Access, Vol. 7, Feb. 1, 2019, pp. 19143-65; (ii) V. Deliá et al., “Speech Technology Progress Based on New Machine Learning Paradigm,” Comput. Intell. Neurosci. Volume 2019, Article ID: 4368036, Jun. 25, 2019; and (iii) A. Mehrish et al., “A Review of Deep Learning Techniques for Speech Processing,” arXiv:2305.00359v3 [eess.AS], May 30, 2023—each of which is incorporated herein by reference.

Mobile computing device 102 is also configured to generate reactionary device data based on the one or more deviations from the baseline characteristics of the live audio stream. In some embodiments, upon determining that one or more deviations have occurred in the live audio stream, mobile computing device 102 can generate reactionary device data corresponding to, e.g., detecting that at least one deviation has occurred, detecting that a certain number of deviations occurred overall, and/or detecting that a defined number of deviations occurred during a specific period (e.g., last 20 seconds), among others. In some embodiments, the reactionary device data comprises programmatic instructions to cause one or more hardware and/or software components of mobile computing device 102 to activate and/or perform a defined function. Exemplary hardware and/or software components of mobile computing device 102 that can be activated or triggered using the reactionary device data include, but are not limited to, a display screen (e.g., display 114), a camera, a camera flash (e.g., light source 112), a haptic module (e.g., haptic engine 118 such as Taptic Engine™ in Apple iPhones®), a microphone, (e.g., microphone 116) a speaker (e.g., speaker 120), or other types of sensory modules or features of mobile computing device 102. In some embodiments, the reactionary device data can cause an external device that is coupled to mobile computing device 102 via a wired or wireless connection (e.g., Bluetooth™ headphones) to activate.

Mobile computing device 102 is also configured to initiate a device reaction based on the reactionary device data. As mentioned above, the reactionary device data can comprise programmatic instructions that are received and executed by a processor and/or operating system of mobile computing device 102. Upon generating the reactionary device data, mobile computing device 102 can use the reactionary device data to initiate a device reaction. In some embodiments, one or more attributes of the device reaction are based upon the deviation(s) from the baseline as determined by mobile computing device 102. For example, when the live audio stream represents a significant deviation from the baseline characteristics, the reactionary device data can activate a plurality of components of mobile computing device 102 and/or greatly increase the attributes of the reaction—e.g., flashing the screen, strongly vibrating the device, and playing a loud sound. In cases where the live audio stream represents a smaller deviation from the baseline characteristics, the reactionary device data can activate one component of mobile computing device 102 and/or set the attributes of the reaction to a lower value—e.g., a single low vibration of mobile computing device 102.

In some embodiments, the device reaction corresponds to a vibration of mobile computing device 102 at the live event. In some embodiments, an intensity of the vibration of mobile computing device 102 is based on the one or more deviations from the baseline characteristics of the live audio stream. In some embodiments, the device reaction corresponds to an illumination of a light source 112 of the mobile computing device 102 at the live event. For example, in some embodiments, the light source 112 of the mobile computing device 102 corresponds to a camera flash of the mobile computing device 102. In other embodiments, the device reaction corresponds to an illumination of a display 114 of the mobile computing device 102 at the live event. In some embodiments, the device reaction corresponds to a notification on a display 114 of the mobile computing device 102 at the live event.

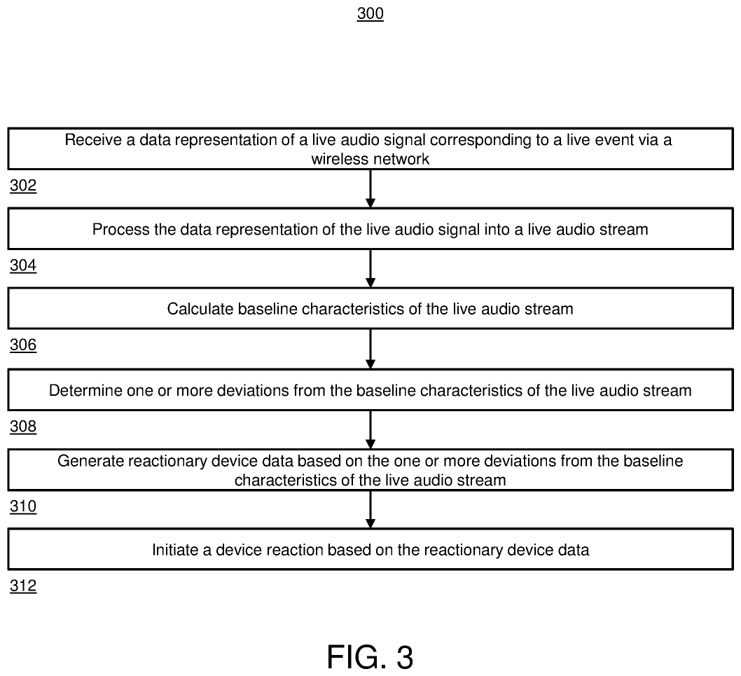

FIG. 3 is a schematic flow diagram of a process 300 for delivery of real-time reactionary device data based on location data at a live event using a mobile computing device 102, according to an illustrative embodiment of the invention. Process 300 begins by receiving, by a mobile computing device 102 at a live event, a data representation of a live audio signal corresponding to the live event via a wireless network 106 at step 302. For example, in some embodiments, the mobile computing device 102 is configured to receive the data representation of the live audio signal corresponding to the live event from an audio server computing device 104 via the wireless network 106.

Process 300 continues by processing, by the mobile computing device 102 at the live event, the data representation of the live audio signal into a live audio stream at step 304. Process 300 continues by calculating, by the mobile computing device 102 at the live event, baseline characteristics of the live audio stream at step 306. For example, in some embodiments, the live audio stream includes live commentary corresponding to the live event. In some embodiments, the baseline characteristics of the live audio stream include an intonation of the commentary, a speech tempo of the commentary, and a loudness of the commentary. In some embodiments, the mobile computing device 102 is configured to calculate the baseline characteristics of the live audio stream using a machine learning algorithm.

Process 300 continues by determining, by the mobile computing device 102 at the live event, one or more deviations from the baseline characteristics of the live audio stream at step 308. For example, in some embodiments, the mobile computing device 102 is configured to determine the one or more deviations from the baseline characteristics of the live audio stream using a machine learning algorithm.

Process 300 continues by generating, by the mobile computing device 102 at the live event, reactionary device data based on the one or more deviations from the baseline characteristics of the live audio stream at step 310. Process 300 finishes by initiating, by the mobile computing device 102 at the live event, a device reaction based on the reactionary device data at step 312. For example, in some embodiments, the device reaction corresponds to a vibration of the mobile computing device 102 at the live event. In some embodiments, an intensity of the vibration of the mobile computing device 102 is based on the one or more deviations from the baseline characteristics of the live audio stream.

In some embodiments, the device reaction corresponds to an illumination of a light source 112 of the mobile computing device 102 at the live event. For example, in some embodiments, the light source 112 of the mobile computing device 102 corresponds to a camera flash of the mobile computing device 102. In other embodiments, the device reaction corresponds to an illumination of a display 114 of the mobile computing device 102 at the live event. In some embodiments, the device reaction corresponds to a notification on a display 114 of the mobile computing device 102 at the live event.

As described above, mobile computing device 102 can be configured to receive and analyze the live audio stream to initiate the device reactions. It should be appreciated that in some embodiments, audio server computing device 104 can perform the process of capturing and analyzing the live audio stream to determine the baseline characteristics and the one or more deviations, while also generating reactionary device data for transmission to mobile computing device 102 to initiate device reactions.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Edge™ available from Microsoft Corporation, and/or Mozilla® Firefox available from Mozilla Corporation). Mobile computing device include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts

While the invention has been particularly shown and described with reference to specific preferred embodiments, it should be understood by those skilled in the art that various changes in form and detail may be made therein without departing from the spirit and scope of the invention as defined by the following claims.

1. A computerized method for generating real-time reactionary device data based on live audio data, the method comprising:
receiving, by a mobile computing device at a live event, a data representation of a live audio signal corresponding to the live event via a wireless network;
processing, by the mobile computing device at the live event, the data representation of the live audio signal into a live audio stream;
calculating, by the mobile computing device at the live event, a plurality of baseline characteristics of the live audio stream;
determining, by the mobile computing device at the live event, one or more deviations from the plurality of baseline characteristics of the live audio stream;
generating, by the mobile computing device at the live event, reactionary device data based on the one or more deviations from the plurality of baseline characteristics of the live audio stream; and
initiating, by the mobile computing device at the live event, a device reaction based on the reactionary device data.

2. The method of claim 1, wherein the mobile computing device at the live event is configured to receive the data representation of the live audio signal corresponding to the live event from an audio server computing device via the wireless network.

3. The method of claim 1, wherein the live audio stream comprises commentary corresponding to the live event.

4. The method of claim 3, wherein the plurality of baseline characteristics of the live audio stream comprise an intonation of the commentary, a speech tempo of the commentary, and a loudness of the commentary.

5. The method of claim 1, wherein the mobile computing device at the live event is configured to calculate the plurality of baseline characteristics of the live audio stream based on a machine learning algorithm.

6. The method of claim 1, wherein the mobile computing device at the live event is configured to determine the one or more deviations from the plurality of baseline characteristics of the live audio stream based on a machine learning algorithm.

7. The method of claim 1, wherein the device reaction corresponds to a vibration of the mobile computing device at the live event.

8. The method of claim 7, wherein an intensity of the vibration of the mobile computing device at the live event is based on the one or more deviations from the plurality of baseline characteristics of the live audio stream.

9. The method of claim 1, wherein the device reaction corresponds to a notification on a display of the mobile computing device at the live event.

10. The method of claim 1, wherein the device reaction corresponds to an illumination of a display of the mobile computing device at the live event.

11. A system for generating real-time reactionary device data based on live audio data, the system comprising:
a mobile computing device at a live event communicatively coupled to an audio server computing device over a network, the mobile computing device at the live event configured to:
receive a data representation of a live audio signal corresponding to the live event via the wireless network;
process the data representation of the live audio signal into a live audio stream;
calculate a plurality of baseline characteristics of the live audio stream;
determine one or more deviations from the plurality of baseline characteristics of the live audio stream;
generate reactionary device data based on the one or more deviations from the plurality of baseline characteristics of the live audio stream; and
initiate a device reaction based on the reactionary device data.

12. The system of claim 11, wherein the mobile computing device at the live event is configured to receive the data representation of the live audio signal corresponding to the live event from the audio server computing device via the wireless network.

13. The system of claim 11, wherein the live audio stream comprises commentary corresponding to the live event.

14. The system of claim 13, wherein the plurality of baseline characteristics of the live audio stream comprise an intonation of the commentary, a speech tempo of the commentary, and a loudness of the commentary.

15. The system of claim 11, wherein the mobile computing device at the live event is configured to calculate the plurality of baseline characteristics of the live audio stream based on a machine learning algorithm.

16. The system of claim 11, wherein the mobile computing device at the live event is configured to determine the one or more deviations from the plurality of baseline characteristics of the live audio stream based on a machine learning algorithm.

17. The system of claim 11, wherein the device reaction corresponds to a vibration of the mobile computing device at the live event.

18. The system of claim 17, wherein an intensity of the vibration of the mobile computing device at the live event is based on the one or more deviations from the plurality of baseline characteristics of the live audio stream.

19. The system of claim 11, wherein the device reaction corresponds to a notification on a display of the mobile computing device at the live event.

20. The system of claim 11, wherein the device reaction corresponds to an illumination of a display of the mobile computing device at the live event.
